(19) United States
(12) Patent Application Publication
(10) Pub. No.: US 2012/0076627 A1
(43) Pub. Date: Mar. 29, 2012

(54) LOAD-HANDLING APPARATUS ADAPTED TO BE MOUNTED ON AN ELEVATABLE LIFT CARRIAGE OF A LIFT TRUCK AS WELL AS A LIFT TRUCK COMPRISING SUCH A LOAD-HANDLING APPARATUS

(75) Inventor: Robert Servaas Matti, Valkenburg (NL)

(73) Assignee: Griptech B.V., Valkenburg (NL)

(21) Appl. No.: 13/320,047

(22) PCT Filed: May 11, 2010
(86) PCT No.: PCT/NL2010/050271

§ 371 Date: Dec. 7, 2011

(30) Foreign Application Priority Data
May 15, 2009 (NL) 1036965

(51) Int. Cl. B66F 9/14

(52) U.S. Cl. 414/667

(57) ABSTRACT

A load-handling apparatus mountable on a lift carriage of a lift truck including at least four parallel guides making up first and second pairs of parallel abutting guides, and at least two oppositely directed hydraulic actuated piston cylinders, wherein at least two load-handling arms are connectable to the cylinders for moving the arms with respect to the guides, wherein each of the arms is moveably supported by a guide, and wherein the first and second pairs of guides are spaced by connection elements.

The invention relates to a load-handling apparatus adapted to be mounted on an elevatable lift carriage of a lift truck, wherein the load-handling apparatus comprises at least four parallel guides making up a first pair of parallel abutting guides and a second pair of parallel abutting guides, at least two oppositely directed and hydraulic actuated piston cylinders, wherein at least two load-handling arms are connectable to said hydraulic actuated piston cylinders for moving said load-handling arms with regard to said guides to and from each other for engaging a load, wherein each load-handling arm is moveably supported by one guide of each pair.

The invention further relates to lift truck comprising such a load-handling apparatus.

Such a load-handling apparatus and lift truck are known from EP-0.628.511. This patent document describes load-handling arms that can be operated by two oppositely directed and hydraulic actuated piston cylinders. Said arms can be moved to and from each other for engaging a load to be transported. It is important to have each load-handling arm moveably supported by one guide of each pair for providing maximum strength to load-handling arms of the load-handling apparatus.

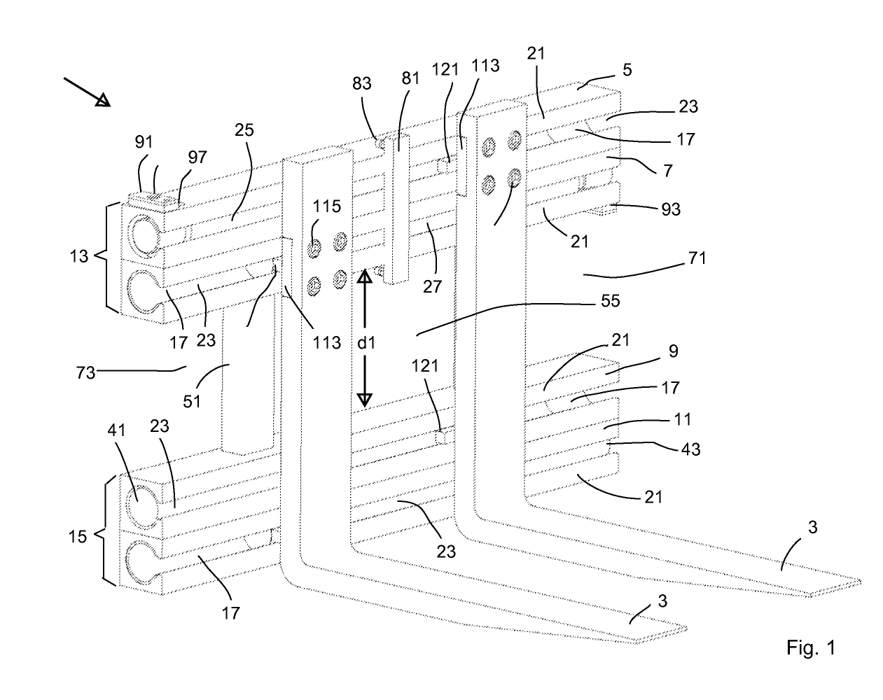

The load-handling apparatus known from EP-0.628.511 further comprises a frame (FIG. 1, reference sign 14) to be connected to an elevatable lift carriage of a lift truck by means of hooks (16) attached to the back side of said frame. The frame connects the back sides of the first upper and second lower pair of guides in such way that the depth dimension of said load-handling apparatus increases.

Therefore, a drawback of such load-handling apparatus known is that it is not compact. In addition said load-handling apparatus has a relatively high weight.

It is therefore an object of the present invention to provide a compact dimensioned load-handling apparatus in a manner compatible with maximum strength.

This object is accomplished with the load-handling apparatus according to the present invention in that the second pair is spaced of said first pair with a distance defined by connection elements lying between the first and the second pair in such a way that said connection elements only influence one dimension of the load-handling apparatus, wherein said influence of said connection elements defines a viewing window between said first and second pairs and said connection elements through which a first side of the load-handling apparatus can be viewed from a second side of the load-handling apparatus.

By means of these connection elements only the vertical height of the load-handling apparatus is being influenced, whereas the depth and width of the load-handling apparatus are not changed by said connection. The maximum depth of these connection elements being determined by the depth of the guides, wherein said depth dimension of the connection elements may maximally be dimensioned identical to the depth of the guides, as the connection elements are not allowed to protrude with respect to said guides. The depth dimension of the load-handling apparatus without the load-handling arms is mainly defined by the depth of the guides, whereas the width dimension of the load-handling apparatus is determined by the longitudinally extending guides with the piston cylinders connected to load handling arms. In this way a maximally compact dimensioned load handling apparatus is provided.

The width of said connection elements does preferably not exceed the depth dimension of the guides such that an optimal viewing window and also viewing spaces are provided on a side of the connection elements opposite of the viewing window. Preferably, the width of the connection elements substantially corresponds to the depth of the connection elements such that pillar or bar shaped connection elements are provided. These pillar or bar shaped connections elements provide maximum strength and occupy minimally space to provide maximum viewability for an operator of the lift truck to view load engaging ends of the load-handling arms in any position.

Further, the weight of the load handling apparatus is drastically reduced by means of the connection elements compared to a frame known from the prior art as these connection elements only need to extend between the first upper and second lower pair of guides. Such weight savings have a positive influence on the load carrying capacity of the lift truck and save energy as the weight of the load-handling apparatus needs always to be carried and moved by the lift truck. The reduced depth of the load handling apparatus also improves the residual capacity of the lift-truck and reduces the turning radius of the lift-truck.

One embodiment of the load handling apparatus according to the present invention is characterised in that each pair comprises at least one hydraulic actuated piston cylinder for actively moving at least one load-handling arm.

In this way in the simplest construction each arm is at least supported and moveable by one hydraulic actuated piston cylinder disposed in one of the guides of the first pair, whereas the same arm is only supported by a guide of the second pair. In a more advanced construction each arm is being movably supported by a first piston cylinder in one of the guides of the first pair and by a second piston cylinder in one of the guides of the second pair. In particular for clamping loads two piston cylinders for each arm may be needed.

Further, it is possible that at least one pair of parallel guides comprises two oppositely directed and hydraulic actuated piston cylinders for actively moving at least two load-handling arms.

In this way each pair can be provided with hydraulic actuated piston cylinders. Further, only one pair can be provided with hydraulic actuated piston cylinders, whereas the other pair only moveably supports these load-handling arms e.g. by means of cylindrical supports.

A preferred embodiment of the load handling apparatus according to the present invention is characterised in that an outer shape of the hydraulic actuated piston cylinder is cylindrical such that an inner sliding surface of the guide is shaped cylindrical, whereas the other sides of at least one guide in at least one pair comprises at least one a flat contact surface to be connected with the elevatable lift carriage of a lift truck.

As no frame is available for mounting said load-handling apparatus to be connected to the elevatable lift carriage of a lift truck, at least one flat contact surface needs to be provided such that the load handling apparatus can be connected to the elevatable lift carriage of a lift truck with maximum strength.

Preferably, all guides are dimensioned substantially identical, wherein in a preferred embodiment each guide comprises at least two flat contact surfaces, i.e. one contact surface of each guide to connect two guides to each other e.g. by welding to provide a pair, whereas the outer back contact surface is used to connect said guide to the elevatable lift carriage of a lift truck. However, it is also possible that two guides of one pair are molded from one piece.

Another embodiment of the load handling apparatus according to the present invention is characterised in that the first and/or the second pair comprise couplings for mounting said load-handling apparatus to the elevatable lift carriage of a lift truck.

By means of couplings, e.g. hooks directly secured to the first and/or the second pair an interchangeable load-handling apparatus is provided. If there are different kind of applications to be performed with one lift truck interchangeable load-handling apparatus can be desired. Further, during maintenance of the lift truck, the load-handling apparatus can still be used by another lift truck or vice versa during maintenance of the load-handling apparatus, the lift truck is available to be used for other purposes.

However, if a lift truck is only used for one purpose and no easy interchangeable load-handling apparatus is needed, it is also possible that the first and the second pair are directly secured to the elevatable lift carriage of a lift truck, e.g. by welding or bolting at least one guide of at least one pair to said lift carriage, more preferably welding each guide to said lift carriage.

Another preferred embodiment of the load handling apparatus according to the present invention is characterised in that the connection elements between the first and the second pair are spaced relatively to each other with a distance corresponding to a horizontal distance between vertically extending lift masts of the lift truck for optimizing visibility through said viewing window.

The distance between lift masts of a lift truck is in general standard, so by adapting the distance between two connection elements to said standard distance between lift masts an optimal viewing window is being provided.

A preferred embodiment of the load handling apparatus according to the present invention is characterised in that the first and/or the second pair comprise a hydraulic fluid discharge and supply unit for the hydraulic actuated piston cylinders which is positioned on a side facing the load-handling arms, preferably said discharge and supply unit is centrally arranged with regard to the longitudinally extending guides.

Such a hydraulic fluid discharge and supply unit influences the viewability through the viewing window minimally.

Another embodiment of the load handling apparatus according to the present invention is characterised in that each piston cylinder being slidably and non-rotatably disposed in one of the guides, wherein each piston cylinder comprises a stationary piston element and a stationary piston rod secured with one end to said piston element, and pivotally secured at its opposite end to said guide.

By pivotally securing the stationary rod to said guide a flexible connection is provided for absorbing forces in use of the load handling apparatus such that maintenance for this connection is reduced drastically compared to a load-handling apparatus having a rigid connection.

A further embodiment of the load handling apparatus according to the present invention is characterised in that each load handling arm comprises at least one recess suited for at least partly receiving a connection plate to be connected to one of the piston cylinders.

By means of this connection plate again the depth dimension of the load handling apparatus is kept minimal. Preferably, these plates are being used for securing the arms to the cylinders by means of fastening means providing a detachable connection if a cylinder needs to be replaced.

Another embodiment of the load handling apparatus according to the present invention is characterised in that each guide comprises a slot on side facing the load-handling arms, which slot extends from one end of the guide to another longitudinally opposing end of the guide.

By means of such a slot the movability of the load-handling arms is maximal

A further embodiment of the load handling apparatus according to the present invention is characterised the maximum and minimum distance between load-handling arms is determined by the length of a cylinder of the piston cylinder which cylinder length is at least 50% of the length of the guide.

The load handling arms can be moved from a substantially abutting relation to each other in a first position to a second position in which the distance between the load handling arms corresponds maximally with at least two times the length of the guides.

The invention will now be explained in more detail with reference to an exemplary embodiment shown in the appended figures, in which:

FIG. 1 shows a perspective view of a load handling apparatus according to the invention, wherein load handling arms are in a first position,

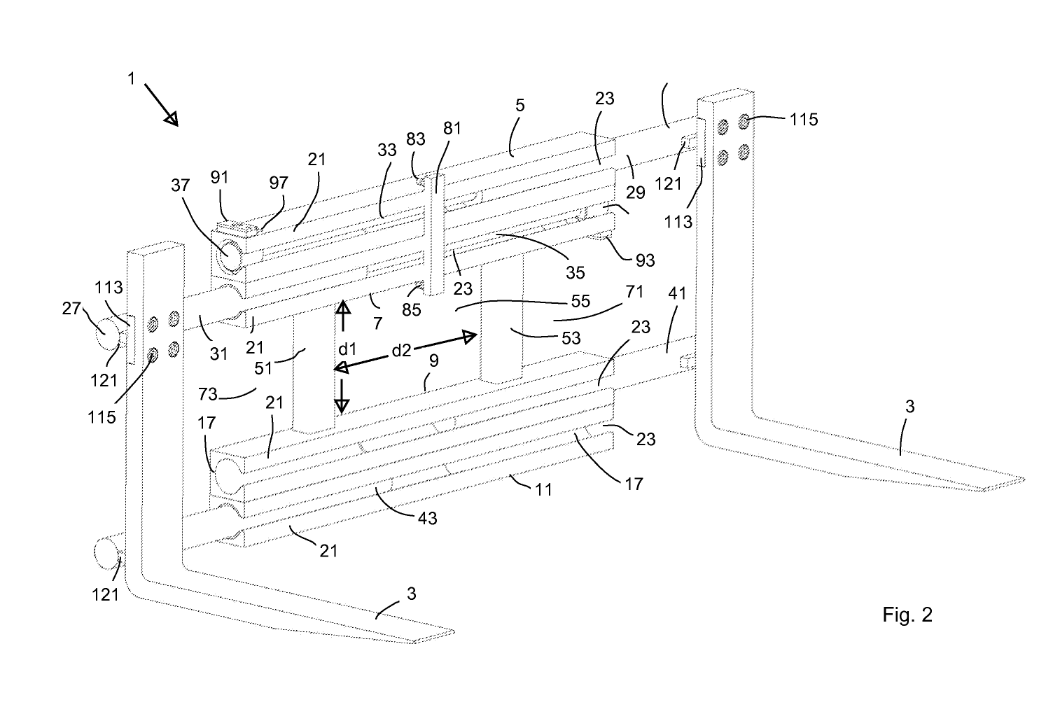

FIG. 2 shows a perspective view of a load handling apparatus according to the invention, wherein load handling arms are in a second position;

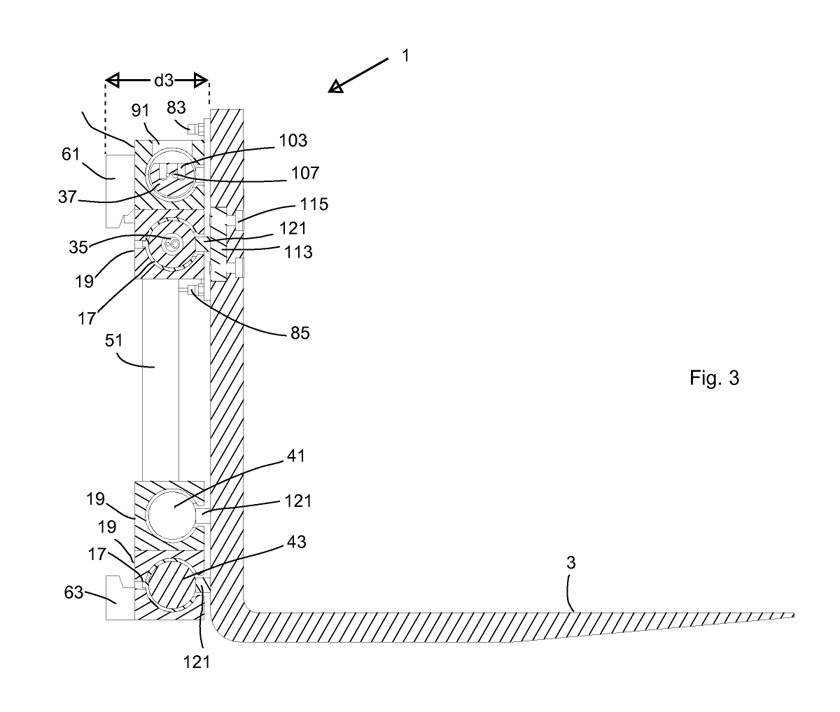

FIG. 3 is a sectional view of a load handling apparatus according to the invention,

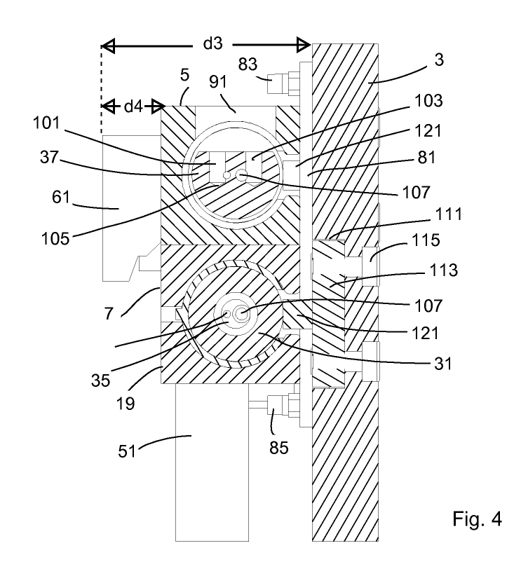

FIG. 4 is an enlargement of the sectional view shown in FIG. 3 showing a part of the load handling apparatus according to the invention.

Like parts are indicated by the same numerals in the various figures.

The load-handling apparatus 1 shown in FIGS. 1-4 uses fork-type load-handling arms 3 capable not only of insertion underneath the bottom of a load (not shown), but also capable of engaging the opposite exterior or interior side surfaces of a load by providing lateral clamping force thereon to lift the load. It will be understood that any type load-handling arms may be used instead of the fork-type load-handling arms 3 shown in the appended figures.

The load-handling apparatus 1 shown comprises four parallel guides 5, 7, 9, 11 making up a first pair 13 of parallel abutting guides 5, 7 and a second pair 15 of parallel abutting guides 9, 11. The guides 5, 7, 9, 11 are substantially identical. Preferably, each pair 13, 15 comprises two rectangle-shaped guides 5, 7, 9, 11, of which a top surface of a first guide 7, 11 has been welded to a bottom surface of a second guide 5, 9. The back side 19 of each guide 5, 7, 9, 11 is a flat contact surface for providing a strong connection with an elevatable lift carriage of a lift truck. The front side 21 of each guide 5, 7, 9, 11 comprises a slot 23 facing the load-handling arms 3, which slot 23 extends from one end of the guide to another longitudinally opposing end of the guide. Further, each guide 5, 7, 9, 11 comprises a hollow interior, in which an inner surface is shaped cylindrical for defining a smooth sliding surface. This sliding surface 17 is formed by a sliding bushing 17.

Within the first upper pair 13 of guides 5, 7 two oppositely directed and hydraulic actuated piston cylinders 25, 27 are situated. Each piston cylinder 25, 27 comprises a slidable and non-rotatable cylinder housing 29, 31, a stationary piston element (not shown) located in said cylinder housing 29, 31 and a stationary piston rod 33, 35 secured with one end to said piston element and secured at its opposite end to a supporting element 37, 39, which supporting element 37, 39 is pivotally secured by means of a pin 95 to said guide 5, 7. A pivotal connection between the piston rod 33, 35 and the guide 5, 7 is advantageous for absorbing forces during use of the load handling apparatus 1.

Within the second pair 13 two slidable cylindrical supports 41, 43 are situated.

Two load-handling arms 3 are connected to the slidable and non-rotatable cylinder housings 29, 31 of said piston cylinders 25, 27 and to slidable cylindrical supports 41, 43 for moving said load-handling arms 3 with regard to said guides 5, 7, 9, 11 to and from each other for engaging a load, such that each load-handling arm 3 is moveably supported by one guide 5, 9; 7, 11 of each pair 13, 15.

In the load-handling apparatus 1 according to the present invention the second pair 15 is spaced of said first pair 13 with a distance d1 defined by connection elements 51, 53 lying between the first 13 and the second pair 15 in such a way that said connection elements 51, 53 only influence one dimension of the load-handling apparatus 1, i.e. only the vertical dimension of the load-handling apparatus 1 according to the present invention. Said influence of said connection elements 51, 53 to the vertical dimension of the load-handling apparatus 1 according to the present invention defines a viewing window 55 between the lower guide 7 of said first 13 pair and the upper guide 9 of said second pair 15 and said connection elements 51, 53 through which a first side of the load-handling apparatus 1 on which first side the load-handling arms are located, can be viewed from a second side of the load-handling apparatus 1 on which second side in use the lift is connected to said load-handling apparatus 1.

The dimensions of the viewing window 55 are defined by the distances d1 between the first 13 and second pair 15, and the distance d2 between the connection elements 51, 53.

By means of the connection elements 51, 53 a maximally compact dimensioned relatively light-weight load handling apparatus 1 can be provided. The depth dimension d3 (FIGS. 3 and 4) of the load-handling apparatus 1 with standard capacity in a range of 2500-3000 kg without the arms 3 is in a range of approximately 90-100 mm, whereas depth dimensions of the load-handling apparatus of the prior art are 140 mm or more. Please note, that the depth dimension of the load-handling apparatus 1 is normally calculated without the optional hook-type couplings 61, 63, i.e. depth dimension of the load-handling apparatus 1 is actually d3 minus d4 such that this actual depth dimension of the load-handling apparatus 1 is the distance between a back of the arms 3 until the back side 19 of the guide 5.

Preferably, the connection elements 51, 53 have been welded to the guides 7, 9 such that compact and strong guides 5, 9, 7, 11 can be constructed in which no space for fastening means needs to be provided in said guides 5, 9, 7, 11 for connecting the connection elements 51, 53 to said guides 5, 9, 7, 11.

In FIGS. 3 and 4 hook-type couplings 61, 63 are shown for mounting said load-handling apparatus 1 to the elevatable lift carriage of a lift truck. Preferably, two hook-type couplings 61 are welded to the backside 19 of the guide 5 of the first pair 13, whereas two hook-type couplings 63 are bolted to the backside 19 of the guide 11 of the second pair 15.

By means of couplings 63 an interchangeable load handling apparatus 1 is provided.

However, it is also possible that the loading apparatus 1 shown in FIGS. 1 and 2 does not comprises any couplings 63, in which case the first 13 and the second pair 15 can directly secured to the elevatable lift carriage of a lift truck, e.g. by welding or bolting. In this way said depth distance d3 of the load handling apparatus is further reduced.

The connection depth dimension d4 of the load-handling apparatus 1 for mounting said load-handling apparatus 1 to a lift truck is defined by the depth of the couplings 63, if present.

Further, it is important that the width of said connection elements 51, 53 does preferably not exceed the depth dimension of the guides 5, 9, 7, 11 such that an optimal viewing window and also viewing spaces 71, 73 are provided on a side of the connection elements 51, 53 opposite of the viewing window 55. Preferably, the width of the connection elements 51, 53 substantially corresponds to the depth of the connection elements 51, 53 such that pillar or bar shaped connection elements 51, 53 are provided. These pillar or bar shaped connections elements 51, 53 provide maximum strength and occupy minimally space to provide maximum viewability through the viewing window 55 and viewing spaces 71, 73 for an operator of the lift truck to view load engaging ends of the load-handling arms in almost any position.

In addition, the two connection elements 51, 53 of the load handling apparatus are spaced relatively to each other with a distance d2 corresponding to a horizontal distance between vertically extending lift masts (not shown) of the lift truck for optimizing visibility through said viewing window 55.

The first pair 13 of guides 5, 7 comprise a centrally arranged hydraulic fluid discharge and supply unit 81 for the hydraulic actuated piston cylinders 25, 27 which is positioned on a front-side facing the load-handling arms 3.

This unit 81 comprises an supply inlet and a discharge outlet (not shown) to which hydraulic couplings of a lift truck may be fastened to provide hydraulic fluid to said moveable cylinder housings 29, 31 for moving them to or from each other. Further, this unit 81 comprises four fluid connectors 83, 85 (only one of the two connectors on the upper and lower side is shown).

The unit 81 provides the oil connection between the two cylinders 25, 27 if both cylinders are situated in one pair of the guides as shown in the figures. This configuration does not affect the depth of the load handling apparatus 1 as there is no space for these connections at the back of the load handling apparatus 1.

Each guide 5, 7 having a hydraulic actuated piston cylinders 25, 27 comprises a connector member 91, 93 at an end of the guide 5, 7 near the supporting element 37, 39. Each connector member 91, 93 comprises a pin 95 for pivotally connecting the supporting elements 37, 39 with the guides 5, 7, 9, 11.

Further, two fluid connectors 97 (only a upper one on the guide 5 is shown in FIGS. 1 and 2) may be connected to the two fluid connectors 83, 85 of the unit 81.

The supporting elements 37, 39 comprise further conduits 101, 103 arranged in a row behind each other to occupy as less space as possible in the longitudinal direction of the guides to ensure a maximal stroke length of the cylinders 25, 27. These conduits 101, 103 connectable with said fluid connectors 97 are in fluid connection in said supporting members 37, 39 with longitudinally extending channels 105, 107 extending through the stationary piston rods 33, 35 as shown in FIG. 4. Through the stationary piston rods 33, 35 fluid is being transported to or from chambers (not shown) divided by means of the piston element in said cylinder housings 29, 31, to move the two cylinder housings 29, 31 connected to the load-handling arms 3 to or from each other.

Further, each load handling arm 3 comprises at least one recess 111 suited for at least partly receiving a connection plate 113 to be connected to one of the piston cylinders 25, 27 by means of fastening means 115. In this way the connection distance needed between the load handling arms 3 and the cylinders 25, 27 is minimal.

The slot 23 extends preferably over the whole longitudinal direction such that there is no movement restriction for the connection 121 between the load handling arms 3 and the cylinders 25, 27 or the cylindrical supports 41, 43, which results in a freely moveably connection 121 through said slot 23. This makes it further possible to have relatively long connections 12 in the longitudinal direction of the guides to provide a strong connection between the arms 3 and the cylinders 25, 27 or the cylindrical supports 41, 43.

It is possible and known as such to provide for specific purposes more than two moveable load handling arms 3, e.g. four, six or more moveable load handling arms to the load-handling apparatus 1.

Instead of using two pillar or bar shaped connection elements 51, 53 it is also possible to use any other shaped connection element as long as only one dimension, i.e. the vertical dimension of the load handling apparatus is being influenced. For example each pillar or bar shaped connection element 51, 53 may be replaced by at least two strip like connection elements in such a way that the two strip like connection elements do not extend outside the depth dimension of the guides.

1. A load-handling apparatus adapted to be mounted on an elevatable lift carriage of a lift truck, the load-handling apparatus comprising:
at least four parallel guides making up a first pair of parallel abutting guides and a second pair of parallel abutting guides; and
at least two oppositely directed and hydraulic actuated piston cylinders;
wherein at least two load-handling arms are connectable to the hydraulic actuated piston cylinders for moving the load-handling arms with regard to the at least four parallel guides to and from each other for engaging a load;
wherein each of the load-handling arms is moveably supported by one guide of each of the first and second pairs of guides and the second pair of guides is spaced from the first pair of guides by a distance defined by connection elements positioned between the first and the second pairs of guides in such a way that the connection elements influence one dimension of the load-handling apparatus; and
wherein the connection elements define a viewing window between the first and second pairs of guides and the connection elements through which a first side of the load-handling apparatus can be viewed from a second side of the load-handling apparatus.

2. The load-handling apparatus according to claim 1, wherein each pair of the first and second pairs of guides comprises at least one hydraulic actuated piston cylinder for actively moving at least one load-handling arm.

3. The load-handling apparatus according to claim 1, wherein at least one pair of the pairs of parallel guides comprises two oppositely directed and hydraulic actuated piston cylinders for actively moving at least two load-handling arms.

4. The load-handling apparatus according to claim 1, wherein the cylinder shape of the at least two hydraulic actuated piston cylinders is cylindrical such that an inner sliding surface of theist respective guide is cylinder shaped, and outer sides of at least one guide of a pair of guides comprise at least one flat contact surface to be connected with the elevatable lift carriage of the lift truck.

5. The load-handling apparatus according to claim 1, at least one of the first and second pairs of guides comprise couplings for mounting the load-handling apparatus to the elevatable lift carriage of the lift truck.

6. The load-handling apparatus according to claim 1, wherein the first and the second pairs of guides are directly secured to the elevatable lift carriage of the lift truck.

7. The load-handling apparatus according to claim 1, wherein the connection elements between the first and the second pair of guides are spaced relative to each other a distance corresponding to a horizontal distance between vertically extending lift masts of the lift truck for optimizing visibility through the viewing window.

8. The load-handling apparatus according to claim 1, wherein at least one of the first and second pairs of guides comprise a hydraulic fluid discharge and supply unit for the at least two hydraulic actuated piston cylinders which is positioned on a side facing the load-handling arms and is centrally arranged with regard to the longitudinally extending guides.

9. The load-handling apparatus according to claim 1, wherein each piston cylinder is slidably and non-rotatably disposed in one of the at least four parallel guides, wherein each piston cylinder comprises a stationary piston element and a stationary piston rod secured with one end to the piston element, and pivotally secured -at its opposite end to its respective one of the at least four parallel guides.

10. The load-handling apparatus according to claim 1, wherein each load handling arm comprises at least one recess for at least partly receiving a connection plate to be connected to one of the piston cylinders.

11. The load-handling apparatus according to claim 1, wherein each of the at least four parallel guides comprises a slot on a side facing the load-handling arms, which slot extends from one end of the guide to another longitudinally opposing end of the guide.

12. The load-handling apparatus according to claim 1, wherein the maximum and minimum distance between load-handling arms is determined by the length of a cylinder of the piston cylinder, which cylinder length is at least 50% of the length of the guide.

13. A lift truck comprising a load-handling apparatus according to claim 1.
